(19) United States
(12) Patent Application Publication
(10) Pub. No.: US 2013/0195186 A1
(43) Pub. Date: Aug. 1, 2013

(54) Scalable Video Coding Extensions for High Efficiency Video Coding

(71) Applicant: FUTUREWEI TECHNOLOGIES, INC., Plano, TX (US)

(72) Inventors: Haoping Yu, Carmel, IN (US); Wen Gao, West Windsor, NJ (US)

(73) Assignee: FUTUREWEI TECHNOLOGIES, INC., Plano, TX (US)

(21) Appl. No.: 13/756,153

(22) Filed: Jan. 31, 2013

Related U.S. Application Data
(60) Provisional application No. 61/593,645, filed on Feb. 1, 2012.

(51) Int. Cl. H04N 7/26

(52) U.S. Cl. CPC H04N 19/00569
USPC 375/240.12

(57) ABSTRACT

A method of scalable video encoding, the method comprising encoding a first video signal using a base layer encoding, and encoding a second video signal using an enhancement layer encoding, wherein the enhancement layer encoding uses inter-layer prediction information based on the first video signal, wherein one of the first video signal or the second video signal has a resolution of 960×540, wherein the second video signal has a higher resolution than the first video signal, and wherein the first video signal is related to the second video signal by a spatial resolution factor that is an integer or an integer ratio.

### CROSS-REFERENCE TO RELATED APPLICATIONS

The present application claims priority to U.S. Provisional Patent Application No. 61/593,645 filed Feb. 1, 2012 by Haoping Yu, et al. and entitled “On Scalable Video Coding Extension of HEVC”, which is incorporated herein by reference as if reproduced in its entirety

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

The amount of video data needed to depict even a relatively short film can be substantial, which may result in difficulties when the data is to be streamed or otherwise communicated across a communications network with limited bandwidth capacity. Thus, video data is generally compressed before being communicated across modern day telecommunication networks. Video compression devices often use software and/or hardware at the source to code the video data prior to transmission, thereby decreasing the quantity of data needed to represent digital video images. The compressed data is then received at the destination by a video decompression device that decodes the video data.

Scalable video coding (SVC) provides support for multiple display resolutions within a single compressed bitstream. The usual modes of scalability include temporal (e.g., frame rate), spatial (e.g., resolution), and quality (or fidelity) scalability. As used herein, SVC focuses mainly on spatial scalability aspects.

The variety of resolutions of current display devices motivates the use of SVC. For example, large format high definition (HD) displays are common for televisions, whereas lower definition displays may be common in applications in which the display is constrained by size or power (e.g., in tablet computers). Transmitting a single representation of a video sequence that can be used by a variety of displays may be impractical. For example, it may not be justifiable to design a small handheld device to process HD video because such a requirement would increase size and/or cost to the point that it defeats the constraints that led to use of a low-resolution display. Due to the proliferation of displays with various resolutions, there is a need to ensure that SVC provides a sufficiently diverse set of video resolutions.

### SUMMARY

In one embodiment, the disclosure includes a method of scalable video encoding, the method comprising encoding a first video signal using a base layer encoding, and encoding a second video signal using an enhancement layer encoding, wherein the enhancement layer encoding uses inter-layer prediction information based on the first video signal, wherein one of the first video signal or the second video signal has a resolution of 960×540, wherein the second video signal has a higher resolution than the first video signal, and wherein the first video signal is related to the second video signal by a spatial resolution factor that is an integer or an integer ratio.

In another embodiment, the disclosure includes a scalable video encoder comprising a processor configured to encode a first video signal using a base layer encoding, and encode a second video signal using an enhancement layer encoding, wherein the enhancement layer encoding uses inter-layer prediction information based on the first video signal, wherein one of the first signal or the second video signal has a resolution of 960×540, wherein the second video signal has a higher resolution than the first video signal, and wherein the first video signal is related to the second video signal by a spatial resolution factor that is an integer or an integer ratio.

In yet another embodiment, the disclosure includes an apparatus comprising a processor configured to downsample a high resolution video signal into one or more lower resolution video signals comprising a base layer video signal, wherein one of the one or more lower resolution video signals has a resolution of 960×540, and encode the high resolution video signal and each of the one or more lower resolution video signals by scalable video encoding, wherein each of the one or more lower resolution video signals is related to the high resolution video signal by a spatial resolution factor that is an integer or an integer ratio.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a two-layer SVC encoder.

FIG. 2 is a schematic diagram of an embodiment of a downsampler.

FIG. 3 is a schematic diagram of an embodiment of a three-layer SVC encoder.

FIG. 4 is a schematic diagram of an embodiment of a SVC decoder.

FIG. 5 is a flowchart of an embodiment of an encoding method.

FIG. 6 is a schematic diagram of a general purpose computer system.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Typically, video media involves displaying a sequence of still images or frames in relatively quick succession, thereby causing a viewer to perceive motion. Each frame may comprise a plurality of picture elements or pixels, each of which may represent a single reference point in the frame. During digital processing, each pixel may be assigned an integer value (e.g., 0, 1, . . . , 255) that represents an image quality or color at the corresponding reference point. The color space may be represented by three components including a luminance (luma, or Y) component and two chrominance (chroma) components, denoted as Cb and Cr (or sometimes as U and V). A luma or chroma integer value is typically stored and processed in binary form using bits. The number of bits used to indicate a luma or chroma value may be referred to as a bit depth or color depth. Hereafter, the notation of a resolution of M₁×M₂ refers to a number of pixels along a horizontal axis of M₁ and a number of pixels along a vertical axis as M₂, where M₁ and M₂ are integers. A resolution may refer to a display or a video signal depending on the context. The resolution of a video signal refers to an array of pixel values corresponding to luma or chroma values, whichever is larger.

In use, an image or video frame may comprise a large amount of pixels (e.g., 2,073,600 pixels in a 1920×1080 frame), thus it may be cumbersome and inefficient to encode and decode (generally referred to hereinafter as code) each pixel independently. To improve coding efficiency, a video frame is usually broken into a plurality of rectangular blocks or macroblocks, which may serve as basic units of processing such as coding, prediction, transform, and quantization. For example, a typical N×N block may comprise N² pixels, where N is an integer greater than one and is often a multiple of four. In the YUV or YCbCr color space, each luma (Y) block corresponds to two chroma blocks including a Cb block and a Cr block. The Cb block and Cr block also correspond to each other. The chroma blocks and their corresponding luma block are may be located in a same relative position of a video frame, slice, or region.

In video coding, various sampling rates may be used to code the YCbCr components. The size of a Cb block, its corresponding Cr block, and/or its corresponding Y block may be the same or different depending on a sampling rate. For example, in a 4:2:0 sampling rate, each N×N chroma (Cb or Cr) block may correspond to a 2N×2N luma block. In this case, a width or height of the chroma block is half that of the corresponding luma block. The chroma components are downsampled or subsampled, since human eyes may be less sensitive to chroma components than to the luma component.

SVC provides support for multiple display resolutions within a single compressed bitstream (or hierarchically related bitstreams). SVC provides advantages over, e.g., simulcast video, wherein the coding of two source video signals (or digital sequences of video frames) of different resolutions may be coded as entirely separate single-layer bitstreams and transmitted as the sum of the two bit rates. SVC provides a mechanism for reusing an encoded lower resolution version of an image sequence for the coding of a corresponding higher resolution sequence.

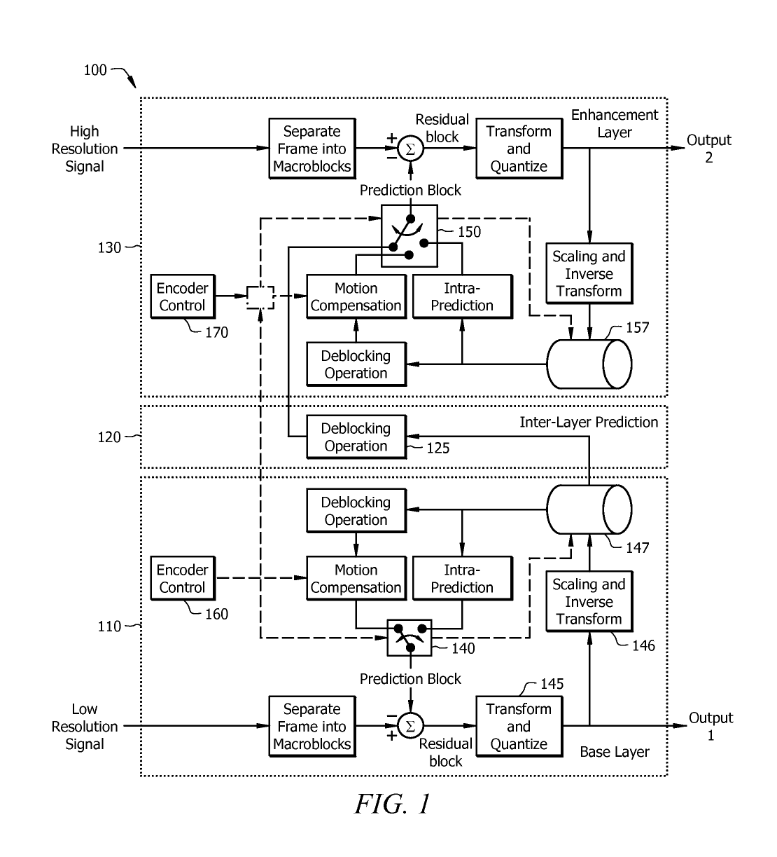

FIG. 1 is a schematic diagram of an embodiment of a two-layer SVC encoder 100. The two-layer encoder 100 provides spatial scalability. As shown in FIG. 1, the encoder 100 comprises a base layer encoder 110, an inter-layer predictor 120, and an enhancement layer encoder 130. The base layer encoder 110 may be configured to receive a low resolution video signal (e.g., a sequence of video frames) as an input. The base layer encoder 110 may encode the low resolution signal using, e.g., high efficiency video coding (HEVC), which is poised to be the next video standard issued by the Joint Collaborative Team on Video Coding (JCT-VC) of the International Telecommunications Union (ITU) Telecommunications Standardization Sector (ITU-T) and International Organization for Standardization (ISO)/International Electrotechnical Commission (IEC). A version of HEVC is defined, for example, in “WD5: Working Draft 5 of High-Efficiency Video Coding” with document number: JCTVC-G1103_d8, which is incorporated by reference as if reproduced in its entirety. As shown, the base layer encoder may separate a frame of video into chroma and luma blocks. Upon generation of a prediction block, a residual block may be generated by subtracting the prediction block from the input block, or vice versa. Prediction blocks may be generated using intra-frame (or intra) prediction methods or motion compensated inter-frame (or inter) prediction methods as shown. Residual blocks may represent prediction residuals or errors. The encoder control module 160 may control the selection of inter versus intra prediction. The selection of inter versus intra prediction is illustrated in FIG. 1 functionally as a switch 140 controlled by encoder control module 160. Since an amount of data needed to represent the prediction residuals may typically be less than an amount of data needed to represent the original block, the residual block may be coded instead of the current block to achieve a higher compression ratio.

Each residual block may be fed into the transform and quantization module 145, which may convert residual samples into a matrix of transform coefficients. Then, the matrix of transform coefficients may be quantized to generate Output 1. Output 1 may be fed into an entropy encoder (not shown) before being transmitted as a compressed video bitstream. The quantization may alter the scale of the transform coefficients and round them to integers, which may reduce the number of non-zero transform coefficients. As a result, a compression ratio may be increased. Quantized transform coefficients may be scanned and encoded by an entropy encoder into an encoded bitstream. Although illustrated as a single module, the transform and quantization module 145 may be implemented as separate modules. The transform employed may be a two-dimensional orthogonal transform, such as a discrete cosine transform (DCT)

The transformed and quantized blocks at the output of the transform and quantization module 145 may be fed into a scaling and inverse transform module 146, which may perform scaling or de-quantization and inverse transform operations on the input blocks. The blocks output from the scaling and inverse transform module 146 may be placed in queue or buffer 147. The blocks in the buffer 147 may be used to generate prediction blocks as shown. The blocks in the buffer 147 may also be used in inter-layer prediction.

The inter-layer predictor 120 predicts enhancement layer data from previously reconstructed data of the base layer encoder 110. For the spatial scalability case, the prediction resulting from the inter-layer predictor 120 may be an up-sampled version of the previously reconstructed base-layer video signals coming from buffer 147. The inter-layer predictor 120 may comprise a deblocking operation module 125 as shown. The previously reconstructed data may be read from the buffer 147. The deblocking operation module 125, typically comprising a deblocking filter, may be applied in the inter-layer prediction layer 120. The deblocking operation may be designed to smooth sharp edges which can form between macroblocks.

The enhancement layer encoder 130 may be configured to receive a high resolution video signal (e.g., a sequence of video frames) as an input. Many aspects of the enhancement layer encoder 130 may be similar to the base layer encoder 110. For convenience, the present disclosure focuses mostly on the aspects that are different. As with the base layer encoder 110, prediction blocks in the enhancement layer encoder 130 may be generated using intra prediction methods or motion compensated inter prediction methods as shown. However, inter-layer prediction may also be used to provide additional coding choices. The encoder control module 170 may control selection of intra prediction, inter prediction, or inter-layer prediction via a switch 150 as shown in FIG. 1. The enhancement layer encoder 130 generates the bitstream Output 2, which may be fed into an entropy encoder (not shown). The outputs Output 1 and Output 2 may be combined into a single bitstream and separated again for processing at an SVC decoder.

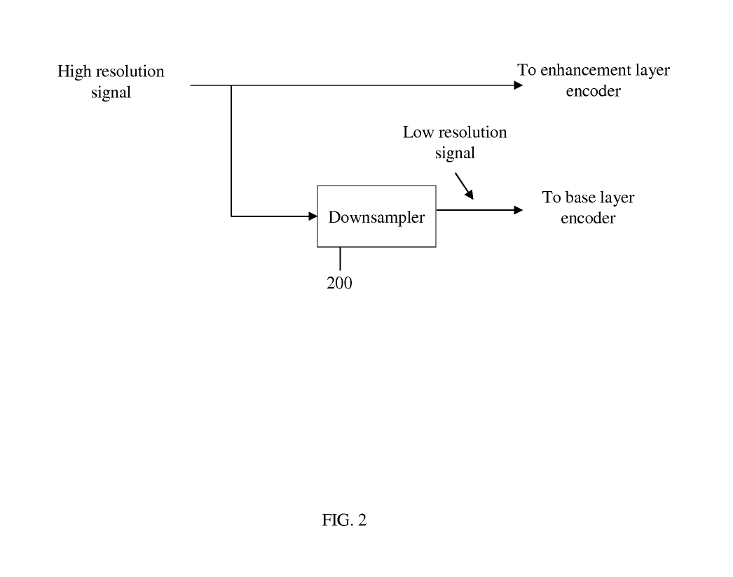

FIG. 2 is a schematic diagram of an embodiment of a downsampler 200. FIG. 2 illustrates the relationship between a high resolution video signal and a low resolution video signal that may be input to an enhancement layer encoder, such as the enhancement layer encoder 130 in FIG. 1, and a base layer encoder, such as the base layer encoder 110 in FIG. 1, respectively. The low resolution video signal may be derived from the high resolution video signal via downsampling in the downsampler 200. The downsampler 200 may employ any of a number of known methods for downsampling. As understood by one of ordinary skill in the art, there are a variety of methods for downsampling. One such method involves simply ignoring or skipping samples in the high resolution signal in a periodic manner. For example, the downsampler 200 may downsample the high resolution signal by a factor of two in the horizontal and vertical directions. That is, every other sample may be used in each row and column in the horizontal and vertical directions, respectively, to provide the low resolution signal. As another example, a downsampling filter may be used by downsampler 200.

An ad-hoc group in the International Standards Organization (ISO) has been established to study SVC in HEVC. A few use cases are listed as follows (taken from the draft use cases document ISO/IEC JTC1/SC29/WG11 AHG on Study of HEVC extensions, “Draft use cases for the scalable enhancement of HEVC (v1)”, M23514, February 2012, San Jose, Calif., which is incorporated by reference as if reproduced in its entirety).
(1) Digital video distributions: the environment of a next generation of digital television distribution is expected to be heterogeneous on both the client as well as the network side. For example, on the client side, multiple (e.g., three) screen scenarios, each screen with different spatial resolution and processing capability, may be common.
(2) Video Conferencing: Video conferencing systems are also rapidly moving towards a multi-screen environment where the display screen could be as small as half-size video graphics array (HVGA) to as large as HD (and potentially 4 k×2 k pixels in the future). Video conferencing systems may be delay sensitive. Video conferencing may take place over networks with dynamically changing conditions, and may need tools to allow fast adaptation to changing conditions which may not require transmission of I frames (or intra-coded pictures).
(3) Three-dimensional (3D) video: An additional layer associated with View Scalability may be relevant to 3D video. For example, two or more views may be captured and all views in addition to a Base view may be compressed by exploiting redundancy across the views.

Scalable extensions of HEVC may be intended to address these use cases. To address these issues, a scalable extension ad-hoc group has created a draft call for proposal (CfP) to solicit technical proposals from a variety of companies and organizations. In this draft CfP, two test categories are addressed, as follows: (1) Category 1: a base layer uses HEVC coding tools and an enhancement layer uses the HEVC standard and its extensions; and (2) Category 2: a base layer uses Moving Picture Experts Group (MPEG)-Advanced Video Coding (AVC)/H.264 High Profile coding tools and an enhancement layer may use the HEVC standard and its extensions. Note that the operation of the encoding layers in the SVC encoder 100 of FIG. 1 is functionally consistent with encoding operations of MPEG-AVC/H.264 and HEVC.

Furthermore, two types of spatial scalabilities may be considered:
(1) An enhancement layer and a base layer with a spatial resolution factor (enhancement/base) of 1.5 in each of x and y directions. The Picture Aspect Ratio (PAR) and Picture Sample Aspect Ratio (PSAR) may be the same in the two layers. The enhancement layer spatial resolution may be 1920×1080 (e.g., HD) and the base layer spatial resolution may be 1280×720. The enhancement and base layers may have the same frame rates.
(2) An enhancement layer and a base layer with a spatial resolution factor (enhancement/base) of 2.0 in each x and y direction. Each layer may have a same PAR and PSAR. There may be two possibilities for the enhancement layer and base layer resolutions: (a) an enhancement layer of 3840×2160×60/50p (i.e., resolution of 3840×2160 with 60/50p frame rate/scanning format) and a base layer of 1920×1080×60/50p; and (b) an enhancement layer of 2560×1600 and a base layer 1280×800.

The spatial resolutions being considered in HEVC (e.g., 1920×1080 or 1280×720) may not be appropriate for small video displays, such as those found on smart phones, because of the form-factor constraints on small devices such as phones.

Disclosed herein are systems, methods, and apparatuses for improved SVC in video coding systems, such as HEVC. Recognizing a need for spatial resolutions appropriate for relatively small displays, new spatial layers are disclosed herein. The new spatial layers provide greater variety in the display devices that may be well served by video coding systems. For example, disclosed herein is the use of 960×540 video as a base layer video coding systems, such as HEVC.

Video or video displays with a resolution of 960×540 may sometimes be referred to herein as quarter HD (QHD) because the number of pixels may be one-quarter that of HD video (1920×1080). QHD together with 1280×720 and HD video formats may be suitable to support a variety of displays, including televisions or large portable device formats (e.g., HD), tablet-size formats (e.g. intermediate format 1280×720), and smartphones (e.g., QHD). The resolution on phones, for example, may be unlikely to increase much beyond QHD because phone displays may be constrained to be less than about 4.5 inches wide in order to fit in clothes pockets. A number of manufacturers, such as MOTOROLA and HTC, may be making phones with a QHD display. Further, the APPLE IPHONE may have a resolution of 960×640 in the IPHONE 4 and 4s models.

The QHD format may be obtained by downsampling HD by a factor of two. For example, a configuration as shown in FIG. 2 may be used, where the downsampler 200 has HD video as an input and downsamples the HD video input by a factor of two in each direction to obtain QHD. Further, a “video thumbnail” resolution of 480×270 may be obtained from HD by downsampling HD by a factor of four in each direction. Video thumbnail may also be obtained by down-sampling QHD by a factor of 2 in each direction.

With these new resolutions, new spatial layers become feasible in HEVC. Table 1 presents three new spatial layer scenarios for HEVC. For the two-layer scenario in Table 1, the base layer comprises QHD and enhancement layer 1 (the only enhancement layer) comprises HD. There is a spatial resolution factor (i.e., downsampling factor) of two in each direction to go from the enhancement layer video stream to the base layer video stream. Two three-layer scenarios are presented in Table 1. In a first scenario, the base layer comprises QHD, enhancement layer 1 comprises intermediate format of 1280×720, and enhancement layer 2 comprises HD. The spatial resolution factor for enhancement layer 2 to enhancement layer 1 is 3/2 in each of the x and y directions (i.e., there are three pixels in each of the x and y directions of the enhancement layer 2 video frames for every two pixels in each of the x and y directions of the enhancement layer 1 video frames), and the spatial resolution factor for enhancement layer 1 to the base layer is 4/3 in the x and y directions. In the second three-layer scenario, the base layer comprises 480×270, the enhancement layer 1 comprises QHD, and the enhancement layer 2 comprises HD. The spatial resolution factor in going from one layer to another is two in each of the x and y directions. The spatial resolution factors are integers or integer ratios, which suggest that lower rate video signals can be derived from higher rate video signals in a straightforward manner, e.g., using conventional downsampling techniques. For example, to go from 1280×720 video to 960×540 video, downsampling by generating three pixels for every four pixels in the 1280×720 frame in each of the x and y directions yields video with a resolution of 960×540. Therefore, the spatial resolution factors for the scenarios in Table 1 provide straightforward and convenient derivation of the lower resolution video from the higher resolution video.

TABLE 1
Spatial layer scenarios.

| | Two-layer | | |
|---|---|---|---|
| | scenario | Three-layer scenarios | |
| Base layer | QHD | QHD | Video thumbnail |
| | (960 × 540) | (960 × 540) | (480 × 270) |
| Enhancement | HD | Intermediate format | QHD |
| layer 1 | (1920 × 1080) | (1280 × 720) | (960 × 540) |
| Enhancement | N/A | HD | HD |
| layer 2 | | (1920 × 1080) | (1920 × 1080) |

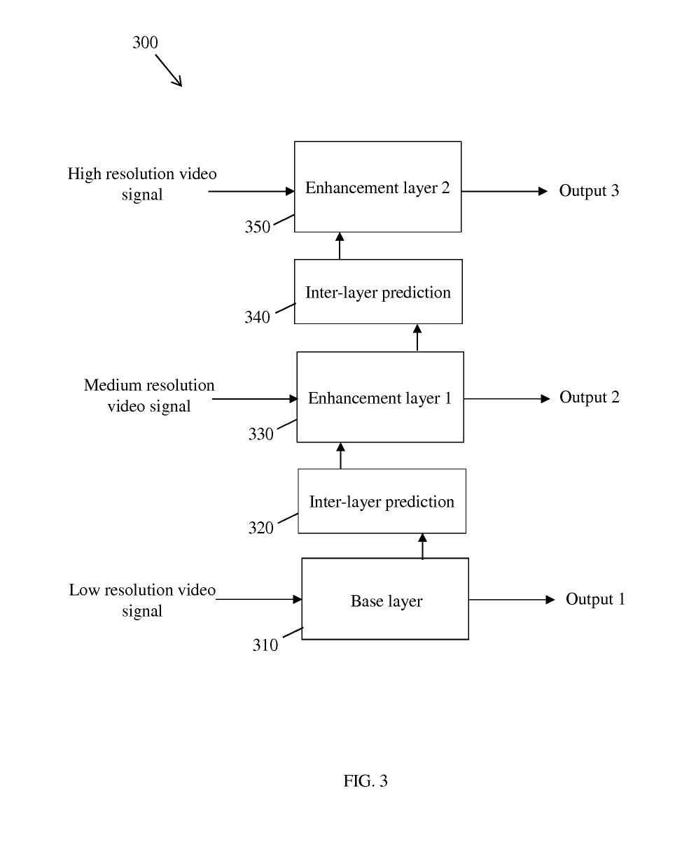

FIG. 3 is a schematic diagram of an embodiment of a three-layer SVC encoder 300. As understood by one of ordinary skill in the art, the three-layer SVC encoder 300 is a logical extension of the two-layer SVC encoder 100. The three-layer SVC encoder 300 comprises a base layer encoder 310, a first inter-layer predictor 320, a first enhancement layer encoder 330, a second inter-layer predictor 340, and a second enhancement layer encoder 350 configured as shown in FIG. 3. The base layer encoder 310 may be configured as the base layer encoder 110 in FIG. 1. Similarly, the first inter-layer predictor 320 and the second inter-layer predictor 340 may be configured as the inter-layer predictor 120 in FIG. 1. That is, the inter-layer predictors 320 and 340 may comprise deblocking filters. The first enhancement layer encoder 330 may be configured the same as the enhancement layer encoder 130 with one difference being that the output of a buffer (which is similar to buffer 157) may be fed into the second inter-layer predictor 340. The output of the second inter-layer predictor 340 may be accounted for in generating prediction blocks in the second enhancement layer encoder 350.

As shown in FIG. 3, the base layer encoder 310 may be configured to receive a low resolution video signal, the first enhancement layer encoder 320 may be configured to receive a medium resolution video signal, and the second enhancement layer encoder 330 may be configured to receive a high resolution video signal. The medium and low resolution video signal may be downsampled versions of the high resolution video signal. The three-layer SVC encoder 300 may be configured to implement the three-layer scenarios in Table 3. For example, the low resolution signal may be QHD resolution, the medium resolution signal may be standard definition resolution, and the high resolution signal may be HD resolution.

As an alternative to the configuration of FIG. 3, each enhancement layer may instead utilize the base layer for inter-layer prediction. The paradigm of FIG. 3 has each enhancement layer after the first enhancement layer utilizing the previous enhancement layer for inter-prediction. One of ordinary skill in the art will readily understand that an encoder with any number of layers may be constructed according to the principles discussed herein.

Given the encoders 100 and 300 in FIGS. 1 and 3, respectively, one of ordinary skill in the art will readily understand that implementation of corresponding video decoders is well understood in the art. For example, when a scalable video signal comprising a base layer signal with resolution of 960×540 QHD, the SVC decoder on a device, such as a phone, may only decode this base layer signal and display the decoded QHD video. The SVC decoder on other more capable devices, such as computer tablet devices, may comprise a base layer decoder, an inter-layer predictor, and an enhancement layer decoder. Further, one of ordinary skill in the art will readily understand that an SVC decoder may be configured as discussed below.

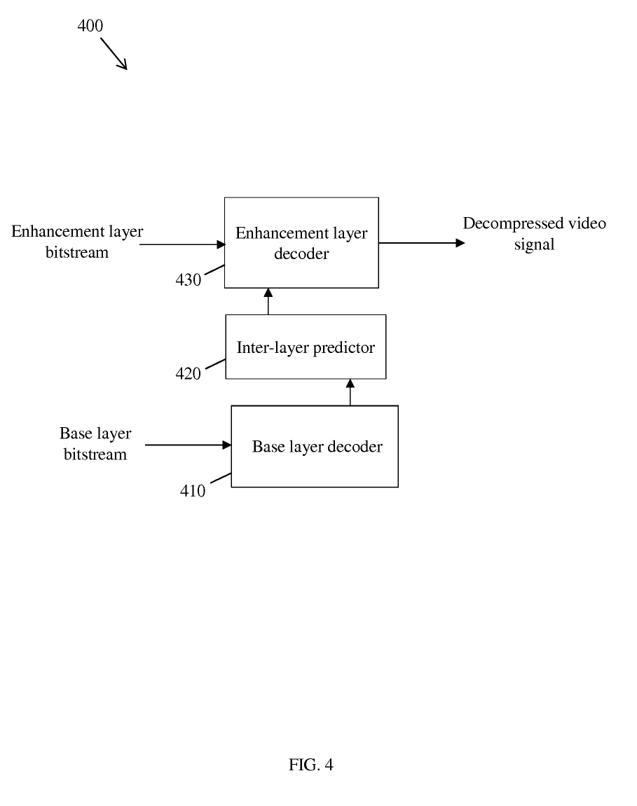

FIG. 4 is a schematic diagram of a SVC decoder 400. The SVC decoder 400 comprises a base layer decoder 410, an inter-layer predictor 420, and an enhancement layer decoder 430. The based layer decoder 410 may decode the base layer bitstream and the decoded/reconstructed base-layer video (e.g. QHD video) may be up-sampled in the inter-layer predictor 420. The enhancement layer decoder 430 may receive the upsampled reconstructed base-layer pixels from the inter-layer predictor 420 as well as an enhancement layer bitstream. The enhancement layer decoder 430 may use the signal, i.e. upsampled decoded/reconstructed base-layer pixels, from the inter-layer predictor 420 in decoding the enhancement layer bitstream to generate enhanced video such as, intermediate format 1280×720 or HD.

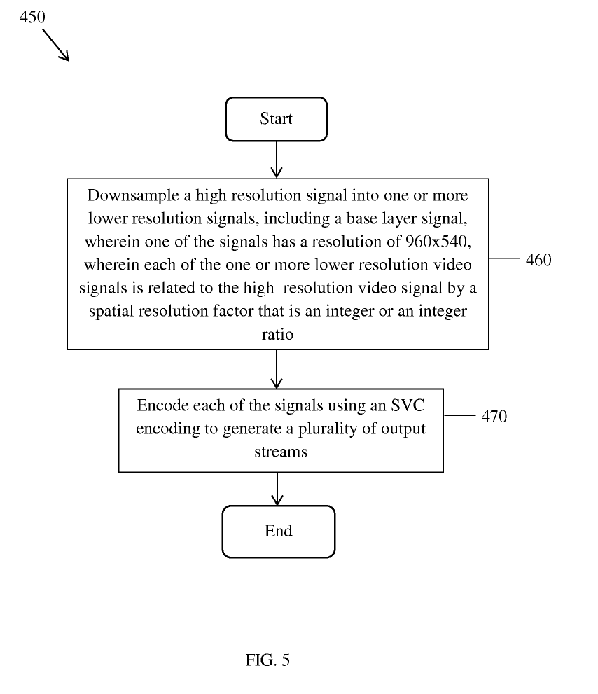

FIG. 5 is a flowchart 450 of an embodiment of an encoding method. The encoding method starts in step 460. In step 460, a high resolution video signal or sequence is downsampled to one or more lower resolution signals or sequences, wherein one of the lower resolution signals or sequences has a resolution of 960×540. The resulting signals or sequences include a base layer signals or sequences and one or more enhancement layer signals or sequences. The downsampling may occur in a downsampler, such as downsampler 200. Next in step 470, each of the signals may be encoded using an SVC encoding process to generate a plurality of output signals. Step 470 may be implemented according to the SVC encoder 100 in FIG. 1 or the SVC encoder 300 in FIG. 3 and the principles discussed herein.

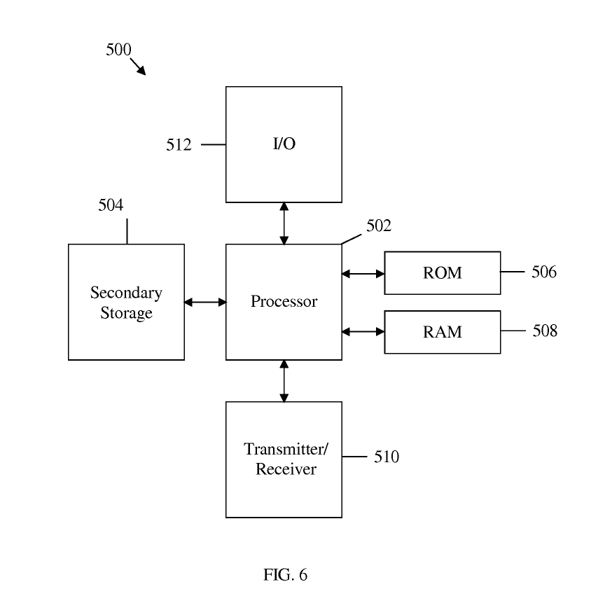

The schemes described above may be implemented on any general-purpose computer system, such as a computer or network component with sufficient processing power, memory resources, and network throughput capability to handle the necessary workload placed upon it. FIG. 6 illustrates a schematic diagram of a general-purpose computer system 500 suitable for implementing one or more embodiments of the schemes, methods, or schematic diagrams disclosed herein, such as the two-layer SVC encoder 100, the three-layer SVC encoder 300, and the flowchart 450 of an embodiment of an encoding method. The computer system 500 includes a processor 502 (which may be referred to as a CPU) that is in communication with memory devices including secondary storage 504, read only memory (ROM) 506, and random access memory (RAM) 508, and in communication with input/output (I/O) devices 512 and transmitter/receiver 510. Although illustrated as a single processor, the processor 502 is not so limited and may comprise multiple processors. The processor 502 may be implemented as one or more CPU chips, cores (e.g., a multi-core processor), field-programmable gate arrays (FPGAs), application specific integrated circuits (ASICs), and/or digital signal processors (DSPs), and/or may be part of one or more ASICs. The processor 502 may be configured to implement any of the schemes described herein, the two-layer SVC encoder 100, the three-layer SVC encoder 300, and the flowchart 450 of an embodiment of an encoding method. The processor 502 may be implemented using hardware, software, or both.

The secondary storage 504 is typically comprised of one or more disk drives or tape drives and is used for non-volatile storage of data and as an over-flow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage 504. The RAM 508 is used to store volatile data and perhaps to store instructions. Access to both ROM 506 and RAM 508 is typically faster than to secondary storage 504.

The transmitter/receiver 510 may serve as an output and/or input device of the computer system 500. For example, if the transmitter/receiver 510 is acting as a transmitter, it may transmit data out of the computer system 500. If the transmitter/receiver 510 is acting as a receiver, it may receive data into the computer system 500. The transmitter/receiver 510 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These transmitter/receiver devices 510 may enable the processor 502 to communicate with an Internet or one or more intranets. The transmitter/receiver 510 may transmit and/or receive outputs from video codecs, such as outputs from SVC encoder 100 or SVC encoder 300.

I/O devices 512 may include a video monitor, liquid crystal display (LCD), touch screen display, or other type of video display for displaying video, and may also include a video recording device for capturing video. The video display may have a resolution of 1920×1080 pixels, 1280×720 pixels, 960×540 pixels, or 480×270 pixels, or any other type of suitable resolution. I/O devices 512 may also include one or more keyboards, mice, or track balls, or other well-known input devices.

It is understood that by programming and/or loading executable instructions onto the computer system 500, at least one of the processor 502, the secondary storage 504, the RAM 508, and the ROM 506 are changed, transforming the computer system 500 in part into a particular machine or apparatus, e.g., a video codec, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The computer system 500 may act as a node in a communication network. Scalable video coding allows a node in a communication network to adjust the bit rate according to the capabilities of the receiver display. For example, in order for a second node with a display with resolution of about 960×540 to display video, the node may transmit only the output from a base layer encoder to the second node, whereas if the second node has a display with a resolution of about 1920×1080, the node may transmit the output from the base layer encoder plus an output from an enhancement layer encoder to the second node. In this way, communication nodes may scale the amount of video information they transmit to other communication nodes.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method of scalable video encoding, the method comprising:
encoding a first video signal using a base layer encoding; and
encoding a second video signal using an enhancement layer encoding, wherein the enhancement layer encoding uses inter-layer prediction information based on the first video signal,
wherein one of the first video signal or the second video signal has a resolution of 960×540,
wherein the second video signal has a higher resolution than the first video signal, and
wherein the first video signal is related to the second video signal by a spatial resolution factor that is an integer or an integer ratio.

2. The method of claim 1, further comprising downsampling the second video signal to obtain the first video signal.

3. The method of claim 1, further comprising encoding a third video signal using a second enhancement layer encoding, wherein the second enhancement layer encoding uses inter-layer prediction information based on the second video signal, and wherein the third video signal has a higher resolution than the second video signal.

4. The method of claim 3, further comprising:
downsampling the third video signal to obtain the second video signal; and
downsampling the third video signal to obtain the first video signal.

5. The method of claim 4, wherein the first video signal has a resolution of 960×540, the second video signal has a resolution of 1280×720, and the third video signal has a resolution of 1920×1080.

6. The method of claim 4, wherein the first video signal has a resolution of 480×270, the second video signal has a resolution of 960×540, and the third video signal has a resolution of 1920×1080.

7. A scalable video encoder comprising:
a processor configured to:
encode a first video signal using a base layer encoding; and
encode a second video signal using an enhancement layer encoding, wherein the enhancement layer encoding uses inter-layer prediction information based on the first video signal,
wherein one of the first video signal or the second video signal has a resolution of 960×540,
wherein the second video signal has a higher resolution than the first video signal, and
wherein the first video signal is related to the second video signal by a spatial resolution factor that is an integer or an integer ratio.

8. The encoder of claim 7, wherein the processor is further configured to downsample the second video signal to obtain the first video signal.

9. The encoder of claim 7, wherein the processor is further configured to encode a third video signal using a second enhancement layer encoding, wherein the enhancement layer encoding uses inter-layer prediction information based on the second video signal, and wherein the third video signal has a higher resolution than the second video signal.

10. The encoder of claim 9, wherein the processor is further configured to:
downsample the third video signal to obtain the second video signal; and
downsample the third video signal to obtain the first video signal.

11. The encoder of claim 10, wherein the first video signal has a resolution of 960×540, the second video signal has a resolution of 1280×720, and the third video signal has a resolution of 1920×1080.

12. The encoder of claim 10, wherein the first video signal has a resolution of 480×270, the second video signal has a resolution of 960×540, and the third video signal has a resolution of 1920×1080.

13. An apparatus comprising:
a processor configured to:
downsample a high resolution video signal into one or more lower resolution video signals comprising a base layer video signal, wherein one of the one or more lower resolution video signals has a resolution of 960×540; and
encode the high resolution video signal and each of the one or more lower resolution video signals by scalable video encoding,
wherein each of the one or more lower resolution video signals is related to the high resolution video signal by a spatial resolution factor that is an integer or an integer ratio.

14. The apparatus of claim 13, wherein the high resolution video signal has a resolution of 1920×1080.

15. The apparatus of claim 13, wherein the one or more lower resolution signals further comprises a medium resolution signal, wherein the medium resolution video signal has a resolution of 1280×720, and wherein the high resolution video signal has a resolution of 1920×1080.

16. The apparatus of claim 13, wherein the one or more lower resolution signals further comprises a medium resolution video signal, wherein the base layer video signal has a resolution of 480×270, the medium resolution video signal has a resolution of 960×540, and the high resolution video signal has a resolution of 1920×1080.

17. The apparatus of claim 13, wherein the encoding comprises:
encoding the base layer video signal using a base layer encoding; and
encoding the high resolution video signal using an enhancement layer encoding, wherein the enhancement layer encoding uses inter-layer prediction information based on the base layer video signal.
